(19) United States
(12) Patent Application Publication
(10) Pub. No.: US 2008/0234020 A1
(43) Pub. Date: Sep. 25, 2008

(54) AGRICULTURAL HARVESTING MACHINE

(76) Inventor: Heinrich Isfort, Duelmen (DE)

Correspondence Address: MICHAEL J. STRIKER, 103 EAST NECK ROAD, HUNTINGTON, NY, 11743, US

(21) Appl. No.: 12/039,155

(22) Filed: Feb. 28, 2008

(30) Foreign Application Priority Data
Mar. 20, 2007 (DE) 10 2007 013 715.1

(51) Int. Cl. A01D 43/00

(52) U.S. Cl. 460/112

(57) ABSTRACT

An agricultural harvesting machine, in particular a forage harvester, has a frame, with a drive unit, an intake conveyor mechanism that directs the crop material to a downstream chopper drum, and a post-fragmentation device located downstream of the chopper drum. A bottom plate that encloses a portion of the chopper drum and is located adjacent to the guide plate in the crop material conveying chute is assigned to the chopper drum. The guide plate, which is located on the bottom of the crop material conveying chute in the region between the chopper drum and the downstream post-fragmentation device is capable of being swiveled vertically around a horizontal pivot axis from a closed position into an open position, and vice versa.

### CROSS-REFERENCE TO A RELATED APPLICATION

The invention described and claimed hereinbelow is also described in German Patent Application DE 10 2007 013 715.1 filed on Mar. 20, 2007. This German Patent Application, whose subject matter is incorporated here by reference, provides the basis for a claim of priority of invention under 35 U.S.C. 119(a)-(d).

### BACKGROUND OF THE INVENTION

The present invention relates to an agricultural harvesting machine.

With agricultural harvesting machines, in particular self-propelled forage harvesters, it is not unusual for jams to occur on one side of the material processing and/or conveying elements, particularly when problematic crop material is harvested or when extremely large quantities of crop material are handled. As a result, the drive motor output may drop off, which results in inadequate throwing action of the material processing devices, e.g., the chopper drum, which are used to convey the chopped material to the downstream material processing devices.

In some cases, jams of this nature may be cleared using known motor-driven reversing devices, although it is often impossible to remove all of the chopped material from the crop material conveying chute adjacent to the chopper drum, and residue often remains in the crop material conveying chute, particularly in the region of the bottom plate and guide plate between the chopper drum and the downstream assemblies. The crop material residue may dry there and cause problems in the subsequent harvesting operation. In addition, clearing jams of this type requires a great deal of time, which means the harvesting operation is interrupted for a longer period of time.

Furthermore, it is known with regard for self-propelled forage harvesters from the manufacturer CNH, model series FX, that the bottom plate may be opened in the lower region of the chopper drum. It is a disadvantage, however, that the bottom plate is screwed together with the housing of the chopper drum, which prevents quick access when jams occur or when chopped material accumulates. To eliminate the problem, the harvesting operation must therefore be interrupted for a longer period of time.

### SUMMARY OF THE INVENTION

The object of the present invention, therefore, is to provide a device inside the crop material conveying chute of an agricultural harvesting machine that eliminates the aforementioned problems of the related art and enables jams and material remaining in the crop material conveying chute to be cleared in a particularly easy manner, without having to interrupt the harvesting operation for longer periods of time.

In keeping with these objects and with others which will become apparent hereinafter, one feature of the present invention resides, briefly stated, in an agricultural harvesting machine, comprising a frame; a drive unit; a downstream chopper drum; an intake conveyor mechanism directing a crop material to said downstream chopper drum; a post-fragmentation device located downstream of said chopper drum; a bottom plate assigned to said chopper drum and enclosing a portion of said chopper drum; a crop material conveying chute; a guide plate located on a bottom plate of said material conveying chute in a region between said chopper drum and said downstream post-fragmentation device, with said bottom plate being located adjacent to said guide plate in said crop material conveying chute, said guide plate being swivelable vertically around a horizontal pivot axis from a closed position into an open position, and vice versa.

Given that the guide plate located on the bottom in the region between the chopper drum and the downstream post-fragmentation device is capable of being swiveled around a horizontal pivot axis from a closed position into an open position, it is ensured that, when jams occur, crop material that accumulates there may drop out when the guide plate is in the open position. Preferably, the guide plate extends across the entire bottom side of the crop material conveying chute in the region between the chopper drum and the downstream post-fragmentation device, so that the largest possible outlet opening is provided through which the accumulated crop material may fall out.

In an advantageous refinement of the present invention, the pivot axis around which the guide plate is swiveled is located at the upper end of the guide plate so that, if jams occur, the crop material—which has accumulated in the upwardly directed crop material conveying chute, that is, in the lower region of the conveyor chute, due to centrifugal force—may drop out of the crop material conveying chute via the shortest route possible when the guide plate is in the open position.

Given that the guide plate—in order to be swiveled—includes a swivel mechanism designed as a transmission system, it is possible to move the guide plate into the open position in a particularly user-friendly manner. It is no longer necessary to loosen screw connections, which is a time-consuming process, thereby making it possible to avoid interrupting the harvesting operation for a long period of time in order to clear any jams that may occur.

Given that the transmission system is essentially composed of at least one transmission element, which is rotatably connected with the guide plate of the crop material conveying chute at one end via a holding device, and which is rotatably connected at the other end with the frame via a further holding device, the guide plate may be swiveled from the closed position into the open position, and vice versa, in a manner that involves a simple design. The at least one transmission element is preferably designed as a telescoping actuator, which, in the simplest case, is designed as a hydraulic motor or an electrical and/or electronic linear motor, thereby making it possible to swivel rapidly from the closed position into the open position when jams occur.

According to a preferred embodiment, the guide plate is swiveled from the closed position into the open position when the chopper drum is decoupled from the drive unit, and/or when the drive unit is switched off, thereby ensuring that, when the chopper drum is moved into a non-operational position and remaining crop material is conveyed into the crop material conveying chute via the after-running of the chopper drum but does not reach the effective region of the downstream processing units, the remaining crop material may drop out through the guide plate, which has been swiveled into the open position. It may also happen that, after a harvesting operation, crop material may accumulate in the crop material conveying chute between the chopper drum and the downstream post-fragmentation device. This accumulated crop material may then be cleared out by swiveling the guide plate into the open position, after the drive unit is switched off.

In an advantageous refinement of the present invention, the swiveling of the guide plate from the closed position into the open position is coupled to the reversing procedure of the chopper drum, so that any remaining crop material that may have been conveyed into the crop material conveying chute during the reversing procedure may drop out of the crop material conveying chute through the open guide plate.

Given that the guide plate is swiveled from the open position into the closed position while the chopping blades of the chopper drum are being sharpened, if water is used for sharpening, it runs out of the opening in the crop material conveying chute. As a result, no water remains in the crop material conveying chute, thereby ensuring that no water is left that could increase the adhesion of the crop material in the crop material conveying chute. In addition, residue from the grinding stone may also drop out of the crop material conveying chute, thereby ensuring that it does not mix with the crop material.

Given that at least one sensor is located at at least one point inside the chopper drum housing, and that the sensor may function as a structure-borne noise receiver—the guide plate being swiveled from the open position into the closed position in response to the sensor signal generated by the sensor—foreign objects detected by the sensor may drop out through the outlet opening of the guide plate, which is located in the open position, thereby preventing greater damage from occurring to the downstream processing units.

In a further advantageous embodiment of the present invention, at least one sensor for measuring torque is located on the chopper drum and/or the downstream processing units. When a predefined torque is exceeded, the guide plate is swiveled from the closed position into the open position, thereby ensuring that any crop material jams that may result from the working units becoming overloaded may be detected and prevented at an early point in time given that the crop material may drop out via the open guide plate before it clogs the crop material conveying chute.

In the simplest case, the swiveling is carried out manually by the operator or automatically using an evaluation and control device. Preferably, a control unit for operating the swivel mechanism is provided inside the driver's cab assigned to the forage harvester, thereby enabling the operator to manually swivel the guide plate from the closed position into the open position—and vice versa—at any time, in order to react quickly and at any time to jams that occur in the crop material conveying chute.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a self-propelled forage harvester, in a side view.

FIG. 2 shows an enlargement of the region labeled “A” in FIG. 1, with the swivelable guide plate in the open position

FIG. 3 shows an enlargement of the region labeled “A” in FIG. 1, with the swivelable guide plate in the closed position

### DESCRIPTION OF THE PREFERRED EMBODIMENTS

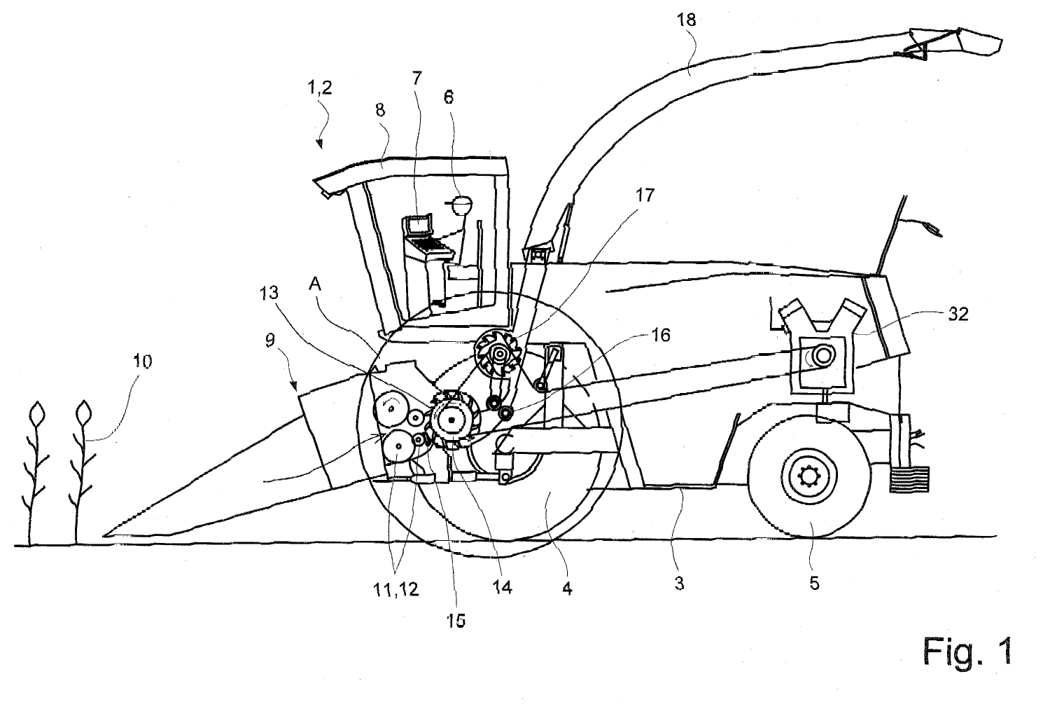

FIG. 1 shows a sectional side view of an agricultural harvesting machine 2 designed as a self-propelled forage harvester 1. It is built on a frame 3, which is carried by front and rear wheels 4, 5. Forage harvester 1 is operated by operator 6 using a control unit 7 in driver's cab 8, from where it is possible to see front attachment 9 attached to the front of forage harvester 1. In the working mode of forage harvester 1, front attachment 9 picks up crop material 10, cuts it and delivers it to downstream intake and compression rollers 11, 12. Intake and compression rollers 10 guide crop material 9 to downstream, rotating chopper drum 13 with blades 13 mounted on it which fragmentize crop material 10 on a shear bar 15.

Fragmentized crop material 10 is subsequently transferred to a post-fragmentation device 16, before it is drawn into post-accelerator 17. The task of post-fragmentation device 16 is to pound the corn kernels, when corn is the crop being harvested. Post-fragmentation device 16 may therefore be eliminated entirely if it is not necessary to pound crop material 10, e.g., when the crop material is grass. Chopped crop material 10 is accelerated by post-accelerator 17, thereby ensuring that it will exit transfer device 18 located downstream of post-accelerator 17 and land in a not-shown hauling vehicle. The processing units described above are driven by drive unit 32, which is located in the rear region.

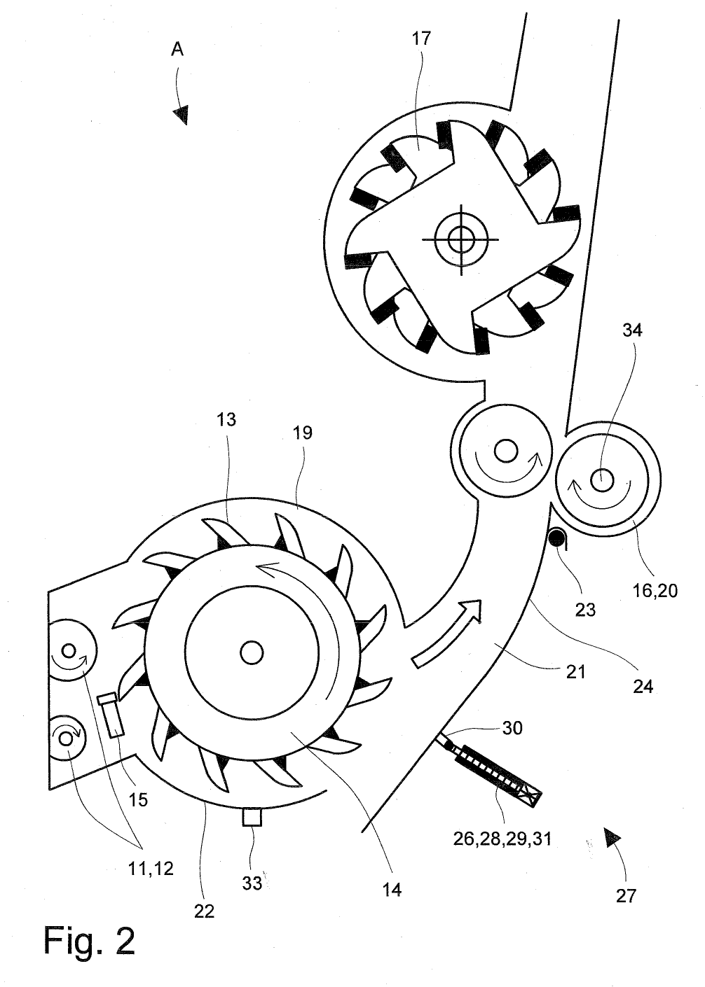

FIG. 2 shows an enlarged sectional view of the region labeled A in FIG. 1, i.e., the crop material flow line in the direction of the arrow, a chopper drum 14 supported in a chopper drum housing 19, a post-fragmentation device 16 in the form of conditioning rollers 20, and a post-accelerator 17. Conditioning rollers 20 transfer chopped crop material 10 to post-accelerator 17, so that it may be conveyed from there via transfer device 18—which is adjustable in the horizontal and vertical directions and is shown in FIG. 1—to a not-shown hauling device assigned to transfer device 18. Chopped crop material 10 flows through crop material conveying chute 21, which is located between chopper drum 14 and post-fragmentation device 16.

A bottom plate 22 is located on the bottom of chopper drum housing 19. Bottom plate 22 is abutted at the top by a guide plate 24, which is capable of being swiveled about pivot axis 23. Guide plate 24 extends along the entire surface between chopper drum 14 and post-fragmentation device 16 in the bottom region of crop material conveying chute 21. In particular, when problematic crop material 10 and/or excessively large quantities of crop material are handled, chopper drum 14 and/or downstream processing units 16, 17, 20 may become overloaded. Optimal conveyance of crop material 10 is therefore no longer ensured and jams may therefore result in the downstream processing units 16, 17, 20 themselves, or in crop material conveying chute 21.

According to the present invention, a guide plate 24 that is capable of being swiveled around a horizontal pivot axis 23 from a closed position into an open position is provided on the bottom of crop material conveying chute 21 in the region between the chopper drum and downstream post-fragmentation device 16. FIG. 2 shows the guide plate in a position that has been swiveled downward, about pivot axis 23, thereby exposing outlet opening 25. A particularly advantageous embodiment results when, as shown in the exemplary embodiment, a swivel mechanism 27 for swiveling guide plate 24 from a closed position into an open position is provided on the bottom center of lower region of guide plate 24. Swivel mechanism 27 is designed as a transmission system 26 and is connected with frame 3 of forage harvester 1 (not shown).

Transmission system 26 includes a telescoping actuator 29 designed as a hydraulic cylinder 28, thereby enabling guide plate 24 to be swiveled from the closed position into the open position, and vice versa, as quickly as possible and using a simple design. Transmission system 26 includes a telescoping actuator 29, which is rotatably connected at one end with the bottom side of guide plate 24 via a holding device 30. Telescoping actuator 29 is rotatably and operatively connected at the other end with frame 3 of forage harvester 1 via a further holding device (not shown). It is also feasible for telescoping actuator 29 to be designed as an electrical or electronic linear motor 31, so that guide plate 24 may be swiveled from the closed position into the open position and vice versa as quickly and exactly as possible.

According to a preferred embodiment, guide plate 24 is swiveled from the closed position into the open position when chopper drum 14 is decoupled from drive unit 32 shown in FIG. 1, and/or when drive unit 32 is switched off, thereby ensuring that, when chopper drum 14 is moved into a non-operational position and remaining crop material 10 is conveyed into crop material conveying chute 21 via the after-running of chopper drum 14 but does not reach the effective region of downstream processing units 16, 17, 20, remaining crop material 14 may drop out through guide plate 24, which has been swiveled into the open position. It may also happen that, after a harvesting operation, crop material may accumulate in crop material conveying chute 21 between chopper drum 14 and downstream post-fragmentation device 16. This accumulated crop material may then be cleared out by swiveling guide plate 24 into the open position, after drive unit 32 is switched off.

It is also feasible for the swiveling of guide plate 24 from the closed position into the open position to be coupled with the reversing procedure of chopper drum 14, or with the procedure for sharpening chopper blades 13 located on chopper drum 14, so that any remaining crop material 10 that may have been conveyed into crop material conveying chute 21 during the reversing procedure may drop out of crop material conveying chute 21 through open guide plate 24. In addition, in a case not described here, water that is used to sharpen chopper blades 13 may run out of outlet opening 25 in crop material conveying chute 21, so that no water remains in crop material conveying chute 21, thereby ensuring that no water is left that could increase the adhesion of crop material 10 in crop material conveying chute 21. Residue from the grinding stone (not shown) may also drop out of crop material conveying chute 21, thereby ensuring that it does not mix with crop material 10.

Advantageously, at least one sensor 33, which may function as a structure-borne noise receiver, is provided on chopper drum housing 19 in order to detect any foreign objects located in crop material 10. In the exemplary embodiment, the at least one sensor 33 is located directly on bottom plate 22 of chopper drum housing 19, in order to register chopped crop material 10 in chopper drum 14. Input signal X, which is generated by the at least one sensor 33, is transmitted to an evaluation and control unit, which is known per se and is therefore not shown here. The evaluation and control unit is operatively connected with telescoping actuator 29 of the swivel mechanism, which is designed as transmission system 26. Based on input signal X that was generated, the evaluation and control unit determines an output signal Y, which triggers the swiveling of guide plate 24 from the closed position into the open position. As a result, the foreign objects registered by sensor 33 may fall through outlet opening 25 when guide plate 24 is in the open position, thereby preventing significant damage to downstream processing units 16,17, 20.

In a further advantageous embodiment of the present invention, at least one sensor 34 (not shown) for measuring torque is located on chopper drum 14 and/or downstream processing units 16, 17, 20. When a predefined torque is exceeded, guide plate 24 is swiveled from the closed position into the open position, thereby ensuring that any crop material jams that may result from chopper drum 14 and downstream processing units 16, 17, 20 becoming overloaded may be detected and prevented at an early point in time given that crop material 10 may drop out via open guide plate 24 before it clogs crop material conveying chute 21.

In the simplest case (not shown here), the swiveling is carried out manually by operator 6 or automatically using an evaluation and control device (not shown). Preferably, a control unit 7 for operating swivel mechanism 27 is provided inside driver's cab 8 assigned to forage harvester 1, thereby enabling operator 6 to manually swivel guide plate 24 from the closed position into the open position at any time, in order to react to jams that occur in crop material conveying chute 21. It is also feasible to provide signal means (not shown) for displaying the current position of guide plate 24 in driver's cab 8, to ensure that operator 6 is always informed of the current swivel position of guide plate 24.

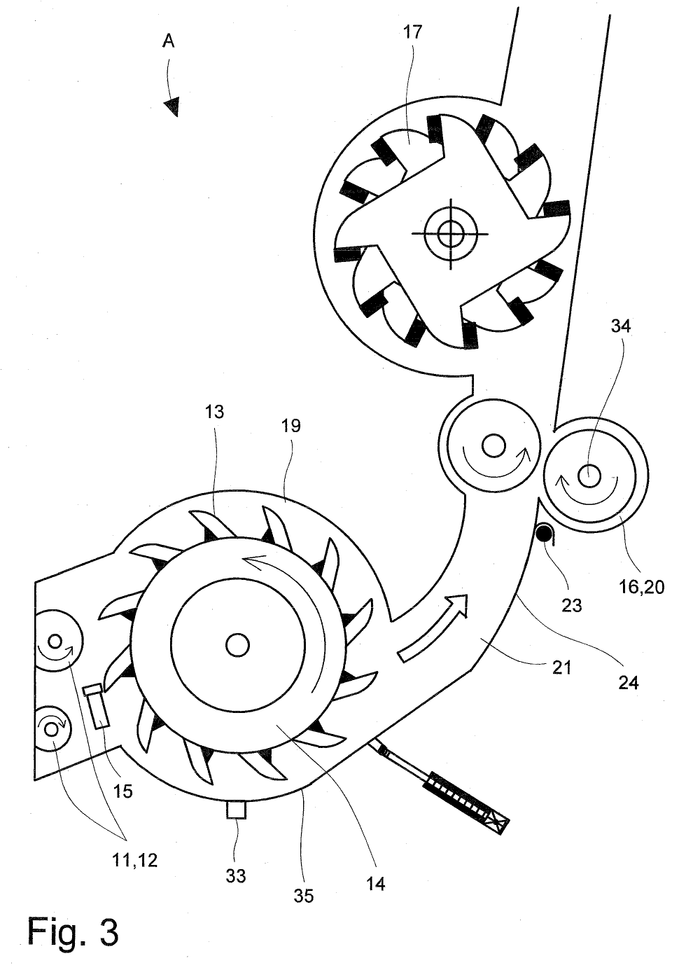

FIG. 3 corresponds to the illustration shown in FIG. 2, but with guide plate 24 shown in the closed position, it being possible to swivel guide plate 24 vertically about horizontal pivot axis 23 from an opened position to a closed position. The lower, end region of guide plate 24 overlaps bottom plate 22, which is assigned to chopper drum housing 19 and serves simultaneously as stop 35 for guide plate 24 when it assumes the closed position. In a further embodiment, which is not shown here, bottom plate 22—as well as guide plate 24—is also designed such that it may be swiveled around a pivot axis using a swivel mechanism. The horizontal axis is located at the top end of bottom plate 22. In interaction with swivelable guide plate, it is therefore possible to obtain a larger outlet opening at the lowest point in crop material conveying chute 21, in order to eliminate the disadvantages described above.

The present invention is not limited to the exemplary embodiment described, and it may be modified in various manners. For example, the present invention may also be designed such that guide plate 24 and/or bottom plate 22 are/is moved from a closed position into an open position not in a swiveling manner, but rather in a displaceable or rotatable manner, or by using other types of motions.

It will be understood that each of the elements described above, or two or more together, may also find a useful application in other types of constructions differing from the type described above.

While the invention has been illustrated and described as embodied in an agricultural harvesting machine, it is not intended to be limited to the details shown, since various modifications and structural changes may be made without departing in any way from the spirit of the present invention.

Without further analysis, the foregoing will so fully reveal the gist of the present invention that others can, be applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. An agricultural harvesting machine, comprising a frame; a drive unit; a downstream chopper drum; an intake conveyor mechanism directing a crop material to said downstream chopper drum; a post-fragmentation device located downstream of said chopper drum; a bottom plate assigned to said chopper drum and enclosing a portion of said chopper drum; a crop material conveying chute; a guide plate located on a bottom plate of said material conveying chute in a region between said chopper drum and said downstream post-fragmentation device, with said bottom plate being located adjacent to said guide plate in said crop material conveying chute and being swivelable vertically around a horizontal pivot axis from a closed position into an open position, and vice versa.

2. An agricultural harvesting machine as defined in claim 1, wherein said guide plate extends along an entire bottom side of said crop material conveying chute in a region between said chopper drum and said downstream post-fragmentation device.

3. An agricultural harvesting machine as defined in claim 1, wherein said guide plate has an upper end, said pivot axis being located at said upper end of said guide plate.

4. An agricultural harvesting machine as defined in claim 1; and further comprising a swivel mechanism configured as a transmission system and operative for swiveling said guide plate.

5. An agricultural harvesting machine as defined in claim 4, wherein said transmission system substantially includes at least one transmission element which is rotatably connected with said guide plate of said crop material conveying chute at one end via a holding device, and which is rotatably connected at another end with said frame via a further holding device.

6. An agricultural harvesting machine as defined in claim 5, wherein said at least one transmission element is configured as a telescopic actuator selected from the group consisting of a hydraulic cylinder and a linear motor.

7. An agricultural harvesting machine as defined in claim 1, wherein said guide plate is configured so that it is swiveled from a closed position into an open position in a situation selected from the group consisting of when said chopper drum is decoupled from said drive unit, when said drive unit is switched off, and both.

8. An agricultural harvesting machine as defined in claim 1, wherein said guide plate is configured so that it is swiveled from a closed position into an open position when said chopper drum is reversed.

9. An agricultural harvesting machine as defined in claim 1, wherein said guide plate is configured so that it is swiveled from a closed position into an open position while cutting blades on said chopper drum are being sharpened.

10. An agricultural harvesting machine as defined in claim 1, wherein said chopper drum has a chopper drum housing; and further comprising at least one sensor located at at least one point inside said chopper drum housing, said sensor being operative as a structure-borne noise receiver, said guide plate being swivelable from a closed position into an open position in response to a sensor signal generated by said sensor.

11. An agricultural harvesting machine as defined in claim 1; and further comprising at least one sensor for measuring torque and located in a position selected from the group consisting on said chopper drum, on downstream processing units, and both, said at least one sensor being configured so that when a previously defined torque is exceeded as determined by said at least one sensor, said guide plate is swiveled from a closed position into an open position.

12. An agricultural harvesting machine as defined in claim 4, wherein said guide plate is configured so that it is swivellable in a manner selected from the group consisting of being swivellable manually by an operator and being swivellable automatically using an evaluation and control device; and further comprising a driver's cab; and a control unit configured for operating said swivel mechanism and located inside said driver's cab.

13. An agricultural harvesting machine as defined in claim 1, wherein the agricultural harvesting machine is configured as a forage harvester.
